(19) United States
(12) Patent Application Publication
(10) Pub. No.: US 2018/0290739 A1
(43) Pub. Date: Oct. 11, 2018

(54) TEETERING TAIL ROTOR YOKE

(71) Applicant: Bell Helicopter Textron Inc., Fort Worth, TX (US)

(72) Inventors: Hassan A. Mughal, Grand Prairie, TX (US); Jared Addison Hallett, Grapevine, TX (US); Andrew Paul Haldeman, Fort Worth, TX (US)

(21) Appl. No.: 15/482,616

(22) Filed: Apr. 7, 2017

(51) Int. Cl. B64C 27/45; B64C 27/82; F16C 23/04

(52) U.S. Cl. CPC B64C 27/45; F16C 2326/43; F16C 23/043; B64C 27/82

(57) ABSTRACT

In one embodiment, a rotorcraft can include a teetering tail rotor assembly. The teetering tail rotor assembly can include one or more multi-bearing yokes. Each yoke can include three or more spherical bearings evenly spaced apart from each other. The teetering tail rotor assembly can include a tail rotor blade affixed to each yoke arm through the three or more spherical bearings. The physical dimensions of the three-bearing yoke can be 10% smaller than a two bearing yoke that can support an equivalent load. For example, the length of each three bearing yoke can be 28 inches, the thickness can be 0.85 inches, and the width can be 3.250 inches.

### TECHNICAL FIELD

This disclosure relates generally to a teetering tail rotor yoke, and more particularly, though not exclusively, to a teetering tail rotor yoke with three or more bearings.

### BACKGROUND

One way of accommodating blade pitch (or feathering) motion in teetering tail rotors is via a spherical bearing affixed to a yoke. The primary force reacted by these bearings is the centrifugal force (CF), which proportionally affects the bearings' load rating for given sizing constraints.

### SUMMARY

According to one aspect of the present disclosure, a tail rotor assembly can include a yoke arm; a rotor blade; and at least three spherical bearings, each of the three spherical bearings carried by the yoke arm and configured to pivotally secure the rotor blade to the yoke arm and to allow feathering movement of the rotor blade relative to the yoke arm during flight.

In some embodiments, the three spherical bearings are evenly spaced from each other on the yoke arm.

In some embodiments, each of the three spherical bearings can include a race; a spherical ball rotatably carried within the housing; and a passage extending through the spherical ball and configured to couple with a first attachment means associated with the rotor blade for securing the rotor blade to the yoke arm.

In some embodiments, the yoke arm has a longitudinal axis, each of the three spherical bearings can include a center line; and wherein the each of the centerlines is aligned with the longitudinal axis of the yoke arm.

In some embodiments, the at least three bearings are configured to allow feathering movement of the rotor blade relative to the longitudinal axis, while restricting transverse and longitudinal movement of the rotor blade relative to the longitudinal axis.

In some embodiments, the yoke arm can include a thickness in the range of 0.75 inches to 1.0 inches.

In some embodiments, the yoke can include a length in the range of 27.5 inches and 28.5 inches.

In some embodiments, the yoke arm comprises a width in a range of 3.0 inches to 3.5 inches.

In one embodiments, a rotorcraft can include a tail rotor assembly, the tail rotor assembly can include a yoke arm; a rotor blade; and at least three spherical bearings, each of the three spherical bearings carried by the yoke arm and configured to pivotally secure the rotor blade to the yoke arm and to allow feathering movement of the rotor blade relative to the yoke arm during flight.

In some embodiments, the three spherical bearings are even spaced from each other on the yoke arm.

In some embodiments, each of the three spherical bearings can include a housing; a spherical ball rotatably carried within the housing; and a passage extending through the spherical ball and configured to couple with a first attachment means associated with the rotor blade for securing the rotor blade to the yoke arm.

In some embodiments, the yoke arm has a longitudinal axis, each of the three spherical bearings can include a center line; and wherein the each of the centerlines is aligned with the longitudinal axis of the yoke arm.

In some embodiments, the at least three bearings are configured to allow feathering movement of the rotor blade relative to the longitudinal axis, while restricting transverse and longitudinal movement of the rotor blade relative to the longitudinal axis.

In some embodiments, the yoke arm can include a thickness in the range of 0.75 inches to 1.0 inches.

In some embodiments, the yoke can include a length in the range of 27.5 inches and 28.5 inches.

In some embodiments, the yoke arm can include a width in a range of 3.0 inches to 3.5 inches.

In one embodiments, a tail rotor yoke for a rotorcraft with a teetering tail rotor can include an elliptically shaped center portion that can receive a tail rotor gearbox; a first yoke arm extending from the center portion, the first yoke arm comprising at least three spherical bearing receiving sections; and a second yoke arm extending from the center portion, the first yoke arm comprising at least three spherical bearing receiving sections.

In some embodiments, the at least three spherical bearing receiving sections are evenly spaced apart.

In some embodiments, the first and second yoke arm can include a thickness in the range of 0.75 inches to 1.0 inches.

In some embodiments, the tail rotor yoke comprises a length in the range of 27.5 inches and 28.5 inches.

### BRIEF DESCRIPTION OF THE DRAWINGS

FIGS. 1A-1B illustrate an example aircraft in accordance with certain embodiments.

FIG. 2 illustrates various components of an aircraft in accordance with embodiments of the present disclosure.

FIG. 3 illustrates a tail rotor assembly of an aircraft in accordance with embodiments of the present disclosure.

FIGS. 4A-D illustrate various views of an example teetering tail rotor yoke with three spherical bearings in accordance with embodiments of the present disclosure.

FIG. 5A is a schematic diagram comparing a three bearing yoke with a two bearing yoke in accordance with embodiments of the present disclosure.

FIG. 5B is a cross-sectional view A-A from FIG. 5A.

### DETAILED DESCRIPTION

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming, it would nevertheless be a routine undertaking for those of ordinary skill in the art having the benefit of this disclosure.

In the specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above,” “below,” “upper,” “lower,” or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction.

Further, the present disclosure may repeat reference numerals and/or letters in the various examples. This repetition is for the purpose of simplicity and clarity and does not in itself dictate a relationship between the various embodiments and/or configurations discussed.

Example embodiments that may be used to implement the features and functionality of this disclosure will now be described with more particular reference to the attached figures.

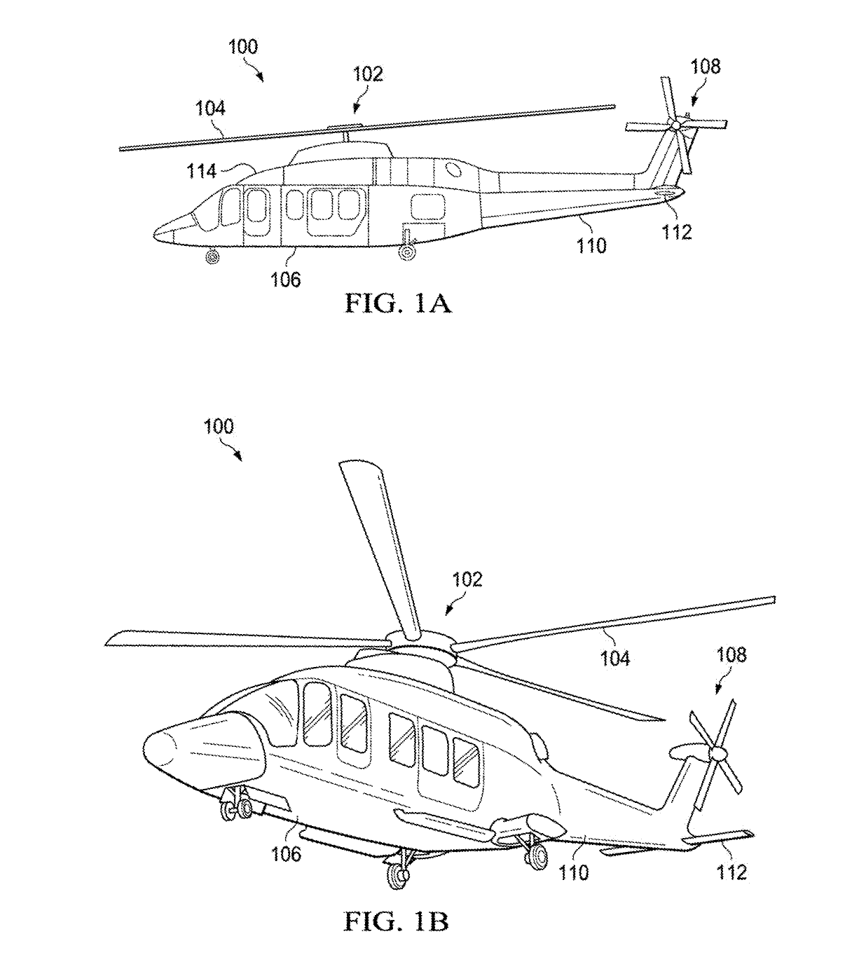

FIGS. 1A and 1B illustrate an example embodiment of a rotorcraft 100. FIG. 1A illustrates a side view of rotorcraft 100, while FIG. 1B illustrates a perspective view of rotorcraft 100. Rotorcraft 100 includes a rotor system 102 with a plurality of rotor blades 104. The pitch of each rotor blade 104 can be managed or adjusted in order to selectively control direction, thrust, and lift of rotorcraft 100. Rotorcraft 100 further includes a fuselage 106, tail rotor or anti-torque system 108, an empennage 110, and a tail structure 112. In the illustrated embodiment, tail structure 112 may be used as a horizontal stabilizer. Torque is supplied to rotor system 102 and anti-torque system 108 using at least one engine.

It should be appreciated that rotorcraft 100 of FIGS. 1A and 1B is merely illustrative of a variety of aircraft that can be used to implement embodiments of the present disclosure. Other aircraft implementations can include, for example, fixed wing airplanes, hybrid aircraft, unmanned aircraft, gyrocopters, a variety of helicopter configurations, and drones, among other examples. Moreover, it should be appreciated that even though aircraft are particularly well suited to implement embodiments of the present disclosure, the described embodiments can also be implemented using non-aircraft vehicles and devices.

This disclosure describes a teetering yoke design that includes three spherical bearings. In embodiments, the three spherical bearings can be equally spaced apart, so that each bearing can react to 33+/−2% of the CF. Compared to yokes with two spherical bearings with a 50-50% split CF reaction, the multiple-bearing yoke described herein improves bearing and yoke life, facilitates weight reduction, improves kinematic clearances, and provides design redundancy in case of single bearing failure.

Example embodiments that may be used to implement the multiple bearing teetering yoke design are described below with more particular reference to the remaining figures.

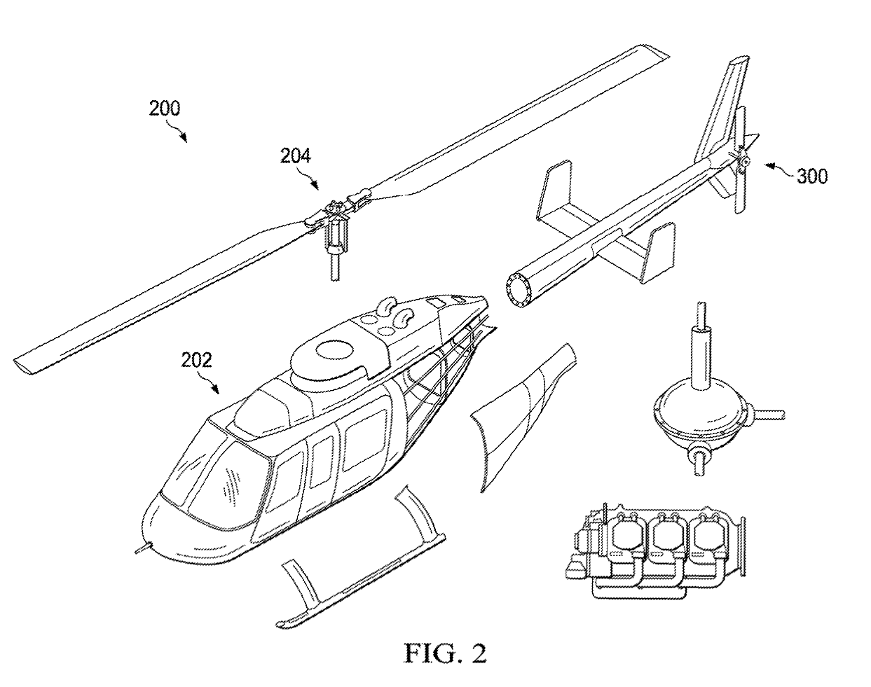

FIG. 2 illustrates various components of an aircraft 200 in accordance with embodiments of the present disclosure. The aircraft 200, which is illustrated in FIG. 2 as a helicopter, includes a fuselage 202, a main rotor system 204, and a tail rotor system 300, among other elements known to those of skill in the art. The fuselage 202, the outer core of the airframe, is an aircraft's main body section that houses the cabin which holds the crew, passengers, and cargo. Helicopter cabins have a variety of seating arrangements. Most have the pilot seated on the right side, although there are some with the pilot seated on the left side or center. The fuselage 202 also houses the engine, the transmission, avionics, flight controls, and the powerplant.

The main rotor system 204 is a rotating part of a helicopter that generates lift. The main rotor system 204 consists of a mast, hub, and rotor blades. The mast is a hollow cylindrical metal shaft which extends upwards from and is driven and sometimes supported by the transmission. At the top of the mast is the attachment point for the rotor blades called the hub. The rotor blades are then attached to the hub by any number of different methods.

The aircraft also includes a tail rotor (or antitorque system) 300 that counter acts torque produced by the rotating main rotor. Helicopters with a single, main rotor system 204 use a separate antitorque system 300. The tail rotor assembly 300 can include a variable pitch, antitorque rotor or tail rotor. Pilots can vary the thrust of the antitorque system to maintain directional control whenever the main rotor torque changes, or to make heading changes while hovering. Most helicopters drive the tail rotor shaft from the transmission to ensure tail rotor rotation (and hence control) in the event that the engine quits. Usually, negative antitorque thrust is needed in autorotations to overcome transmission friction.

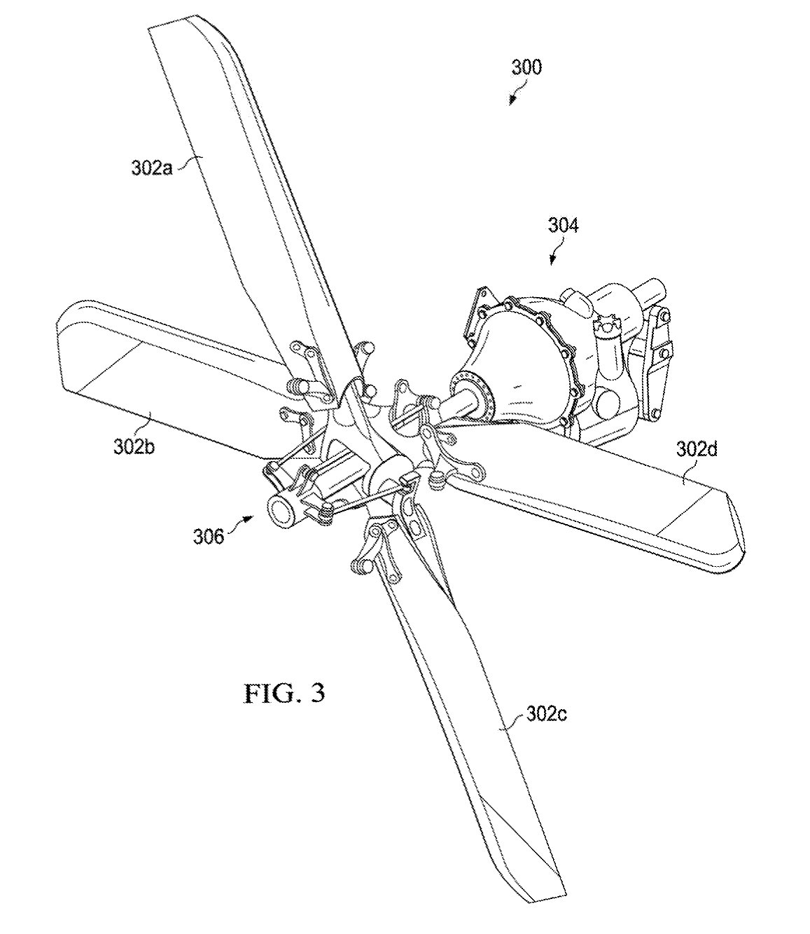

FIG. 3 illustrates a tail rotor assembly 300 of an aircraft in accordance with embodiments of the present disclosure. The tail rotor assembly 300 can include a plurality of rotor blades 302a-d. Rotor blades 302a and 302c can be secured onto the tail rotor assembly 300 by a tail rotor yoke (such as the three bearing tail rotor yoke 400). Similarly, rotor blade 302b and 302d can be secured onto the tail rotor assembly 300 by another tail rotor yoke.

In the exemplary embodiment, tail rotor assembly 300 includes four rotor blades 302a-d; however, it will be appreciated that tail rotor assembly 300 is adaptable for use with more or fewer blades in an alternative embodiment.

Tail rotor assembly 300 can include a tail rotor hub 306 that can secure one or more tail rotor yokes 400. Each tail rotor yoke 400 can secure two tail rotor blades.

The tail rotor assembly 300 can include a tail rotor drive system 304. The tail rotor drive system 304 can include an antitorque drive shaft and an antitorque transmission mounted at the end of a tail boom. The drive shaft may consist of one long shaft or a series of shorter shafts connected at both ends with flexible couplings. This allows the drive shaft to flex with the tail boom. The tail rotor transmission provides a right angle drive for the tail rotor and may also include gearing to adjust the output to optimum tail rotor rpm. Tail rotors may also have an intermediate gearbox to turn the power up a pylon or vertical fin.

The tail rotor assembly 300 can include a plurality of yoke arms, such as yoke arm 401. Two tail rotor blades e.g., 302a-302c can be secured to each yoke 401. Each yoke can include six spherical bearings, three on each yoke arm of the yoke. Each of the three spherical bearings carried by the yoke arm and configured to pivotally secure the rotor blade to the yoke arm and to allow feathering movement of the rotor blade relative to the yoke arm during flight. The three spherical bearings are evenly spaced from each other on the yoke arm. For example, the bearings can be spaced 3 inches apart.

Each of the three spherical bearings can include a race or housing, a spherical ball rotatably carried within the housing; and a passage extending through the spherical ball and configured to couple with a first attachment means associated with the tail rotor blade for securing the rotor blade to the yoke arm. The passage extending through the spherical ball can permit the attachment means for securing the tail rotor blade to the yoke arm. The attachment means can be a bolt or other attachment means.

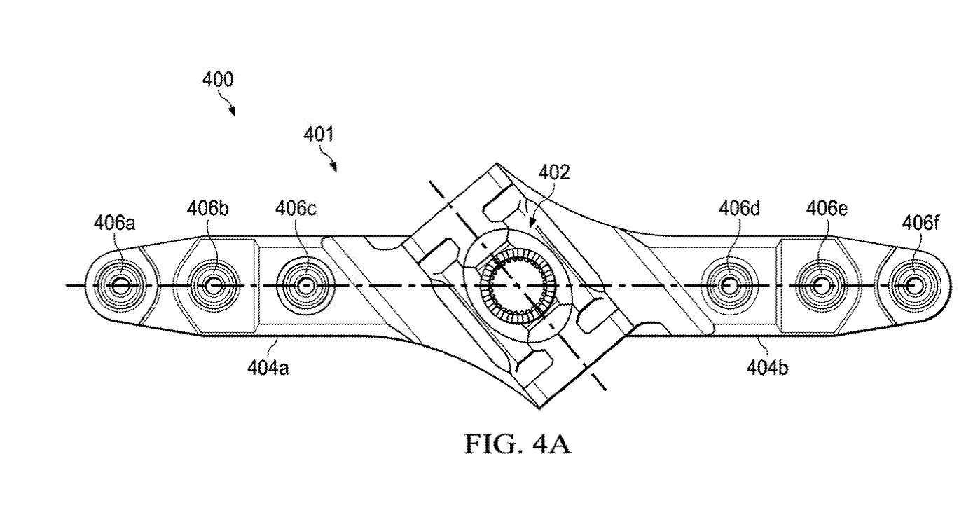

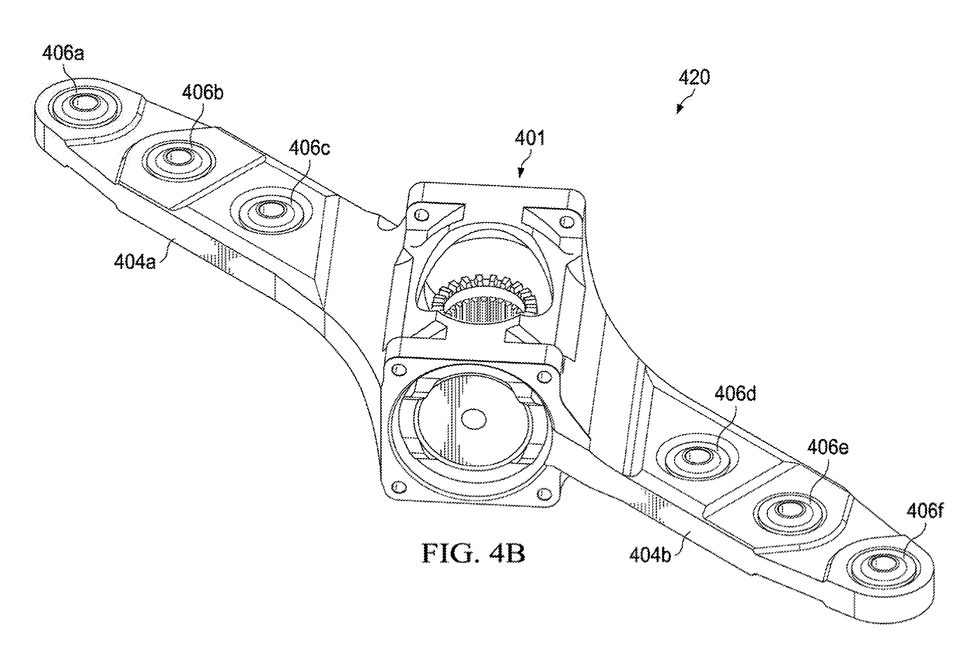

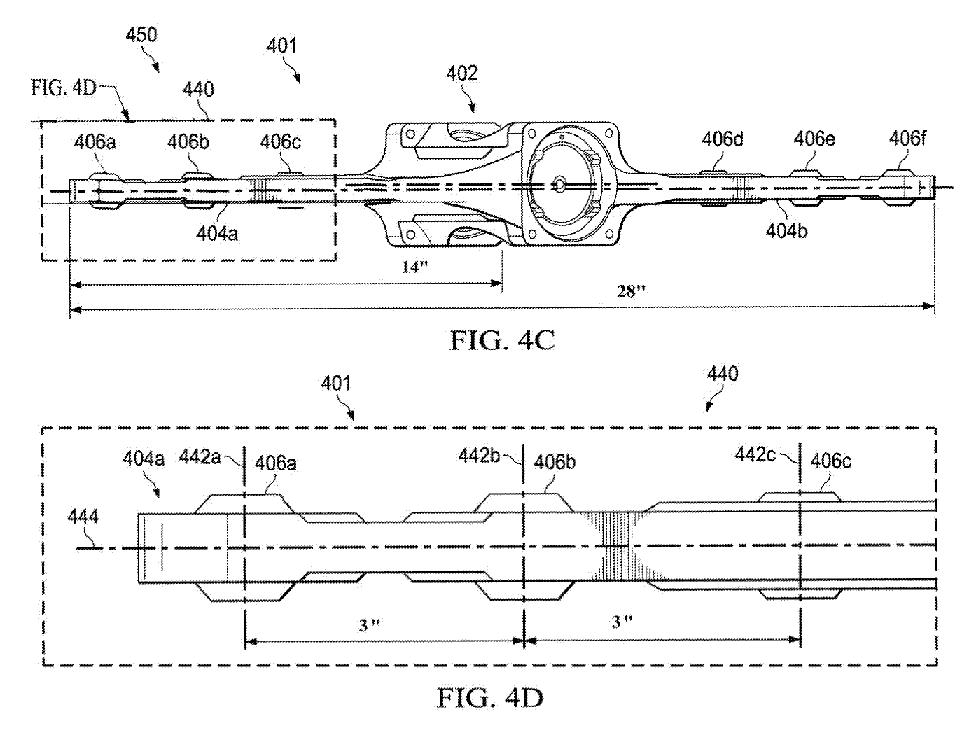

FIGS. 4A-D illustrate various views of an example teetering tail rotor yoke with three spherical bearings in accordance with embodiments of the present disclosure. FIG. 4A is a top-down view 400 of the three bearing teetering tail rotor yoke 401 (three bearing yoke, for short) in accordance with embodiments of the present disclosure. FIG. 4B is an isometric view 420 of the three bearing teetering tail rotor yoke 401. FIG. 4C is a side view 430 of the three bearing yoke 401. FIG. 4D is a close-up of a yoke arm 404a of the yoke 401.

The three bearing yoke 401 has a center section 402 and two arms 404a and 404b. The center section 402 accommodates a flapping bearing which engages with a tail rotor mast, thereby attaching the teetering rotor to the drive system. The center section 402 can have an elliptical shape, which can reduce the weight of the yoke 400, while enabling optimization of localized stresses and strains.

Each of the two arms 404a and 404b facilitate attachment to rotor blades that are underslung relative to the flapping hinge. The blades are attached to the yoke 400 via spherical bearings 406a-c and 406d-f, three on each arm, equally spaced apart and centered at the Pitch Change Axis (PCA). The flapping hinge is oriented at a desired angle relative to the Mean Aerodynamic Chord (MAC) of the blade to induce a Delta-3 hinge. Lastly, the center section has provisions to preload the flapping bearing at install as necessary.

The yoke 400 is shown with three bearings on each yoke arm. Yoke arm 404a includes a first bearing 406a, a second bearing 406b, and a third bearing 406c, each of the bearings being configured to allow feathering movement of the blade relative to the yoke arm 404a. Yoke arm 404b includes a first bearing 406d, a second bearing 406e, and a third bearing 406f, each of the bearings being configured to allow feathering movement of the blade relative to the yoke arm 404b. In the preferred embodiment, the bearings 406a-f are spherical bearings that sit flush with an upper surface and a lower surface of yoke arms; however, it will be appreciated that other types of bearings and devices could be used in lieu of the preferred embodiment. The spherical bearings allow for feathering motion of the rotor blades, which provides significant advantageous over conventional tail rotors, namely tail rotors having rotor blades rigidly attached to the yoke arm.

Turning to FIG. 4D, one yoke arm 404a of the yoke 401 is shown. Yoke arm 404a includes a longitudinal axis 444. Each earing 406a-c has a centerline axis 442a-c, respectively, that defines a center axis through the bearing orthogonal to the longitudinal axis 444. Each of the centerlines 442a-c is aligned with the longitudinal axis 444 of the yoke arm 404a. The three bearings 406a-c are configured to allow feathering movement of a rotor blade relative to the longitudinal axis 444 of the yoke arm 404a, while restricting transverse and longitudinal movement of the rotor blade relative to the longitudinal axis 444. It is understood that yoke arm 404b is substantially similar as yoke arm 404a.

The spherical bearings can be attached or affixed to the yoke arm (e.g., via swaging or staking). A rotor blade can be attached to a yoke through the three or more spherical bearings. Each of the three or more spherical bearings can restrict longitudinal and transverse movement of the rotor blade relative to the yoke. Feathering of the blade can be compensated for by the at least three spherical bearings that allow for pivoting movement of the rotor blade relative to the yoke.

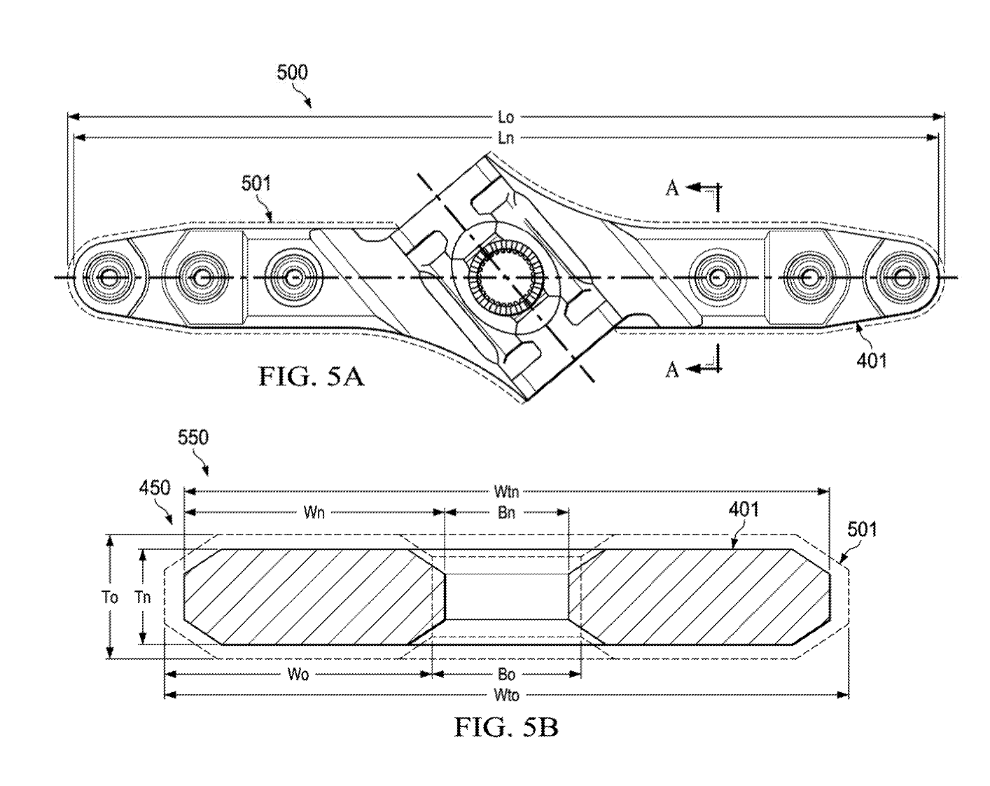

FIG. 5A is a schematic diagram 500 comparing a three bearing yoke with a two bearing yoke in accordance with embodiments of the present disclosure. The three bearing yoke 401 is illustrated. The two bearing yoke 501 is illustrated as an outline around the three bearing yoke 401. The two bearing yoke 501 can have a typical length Lo of 28.5 inches. By way of non-limiting example, the three bearing yoke 401 of the present disclosure can have a length Ln of 28.00 inches, which can accommodate a typical CF load of 26,000 lbf.

More generally, the three bearing yoke can have dimensions being of 10% reduction in cross-sectional area for the most highly loaded bearing location, which translates into material and weight savings. The actual dimensions of the three bearing yoke can be based on application specificity, such as CF loads and/or design packaging.

FIG. 5B is a cross-sectional view A-A 550 from FIG. 5A. The cross sectional view 550 illustrates the two bearing yoke 501 as a dotted line around the three bearing yoke 401. Example dimensions of the two bearing yoke are shown:

TABLE 1
Example dimensions of two bearing yoke in inches

| | |
|---|---|
| Width total Wto | 3.625 |
| Width from edge to bearing Wo | 0.9125 |
| Bearing gap Bo | 1.8 |
| Thickness To | 1.10 |
| Length Lo | 28.5 |

TABLE 2
Example dimensions of three bearing yoke in inches

| | |
|---|---|
| Width total Wtn | 3.250 |
| Width from edge to bearing Wn | 0.875 |
| Bearing gap Bn | 1.5 |
| Thickness Tn | 0.85 |
| Length Ln | 28.0 |

The bearing gap Bo represents a diameter of the spherical bearing for the two bearing yoke. The two bearing yoke 501 would use a larger spherical bearing than the three bearing yoke 401, so that Bo>Bn. The use of smaller bearings include cost savings on the bearings and a more compact design packaging.

The flowcharts and diagrams in the figures illustrate the architecture, functionality, and operation of possible implementations of various embodiments of the present disclosure. It should also be noted that, in some alternative implementations, the function(s) associated with a particular block may occur out of the order specified in the figures. For example, two blocks shown in succession may, in fact, be executed substantially concurrently, or the blocks may sometimes be executed in the reverse order or alternative orders, depending upon the functionality involved.

Although several embodiments have been illustrated and described in detail, numerous other changes, substitutions, variations, alterations, and/or modifications are possible without departing from the spirit and scope of the present invention, as defined by the appended claims. The particular embodiments described herein are illustrative only, and may be modified and practiced in different but equivalent manners, as would be apparent to those of ordinary skill in the art having the benefit of the teachings herein. Those of ordinary skill in the art would appreciate that the present disclosure may be readily used as a basis for designing or modifying other embodiments for carrying out the same purposes and/or achieving the same advantages of the embodiments introduced herein. For example, certain embodiments may be implemented using more, less, and/or other components than those described herein. Moreover, in certain embodiments, some components may be implemented separately, consolidated into one or more integrated components, and/or omitted. Similarly, methods associated with certain embodiments may be implemented using more, less, and/or other steps than those described herein, and their steps may be performed in any suitable order.

Numerous other changes, substitutions, variations, alterations, and modifications may be ascertained to one of ordinary skill in the art and it is intended that the present disclosure encompass all such changes, substitutions, variations, alterations, and modifications as falling within the scope of the appended claims.

In order to assist the United States Patent and Trademark Office (USPTO), and any readers of any patent issued on this application, in interpreting the claims appended hereto, it is noted that: (a) Applicant does not intend any of the appended claims to invoke paragraph (f) of 35 U.S.C. § 112, as it exists on the date of the filing hereof, unless the words “means for” or “steps for” are explicitly used in the particular claims; and (b) Applicant does not intend, by any statement in the specification, to limit this disclosure in any way that is not otherwise expressly reflected in the appended claims.

What is claimed is:

1. A tail rotor assembly comprising:
a yoke arm;
a rotor blade; and
at least three spherical bearings, each of the three spherical bearings carried by the yoke arm and configured to pivotally secure the rotor blade to the yoke arm and to allow feathering movement of the rotor blade relative to the yoke arm during flight.

2. The tail rotor assembly of claim 1, wherein the three spherical bearings are evenly spaced from each other on the yoke arm.

3. The tail rotor assembly of claim 1, wherein each of the three spherical bearings comprises:
a race;
a spherical ball rotatably carried within the housing; and
a passage extending through the spherical ball and configured to couple with a first attachment means associated with the rotor blade for securing the rotor blade to the yoke arm.

4. The tail rotor assembly of claim 1, wherein the yoke arm has a longitudinal axis, each of the three spherical bearings comprising a center line; and
wherein the each of the centerlines is aligned with the longitudinal axis of the yoke arm.

5. The tail rotor assembly of claim 4, wherein the at least three bearings are configured to allow feathering movement of the rotor blade relative to the longitudinal axis, while restricting transverse and longitudinal movement of the rotor blade relative to the longitudinal axis.

6. The tail rotor assembly of claim 1, wherein the yoke arm comprises a thickness in the range of 0.75 inches to 1.0 inches.

7. The tail rotor assembly of claim 6, wherein the yoke comprises a length in the range of 27.5 inches and 28.5 inches.

8. The tail rotor assembly of claim 6, wherein the yoke arm comprises a width in a range of 3.0 inches to 3.5 inches.

9. A rotorcraft comprising:
a tail rotor assembly, the tail rotor assembly comprising:
a yoke arm;
a rotor blade; and
at least three spherical bearings, each of the three spherical bearings carried by the yoke arm and configured to pivotally secure the rotor blade to the yoke arm and to allow feathering movement of the rotor blade relative to the yoke arm during flight.

10. The rotorcraft of claim 9, wherein the three spherical bearings are even spaced from each other on the yoke arm.

11. The rotorcraft of claim 9, wherein each of the three spherical bearings comprises:
a housing;
a spherical ball rotatably carried within the housing; and
a passage extending through the spherical ball and configured to couple with a first attachment means associated with the rotor blade for securing the rotor blade to the yoke arm.

12. The rotorcraft of claim 9, wherein the yoke arm has a longitudinal axis, each of the three spherical bearings comprising a center line; and
wherein the each of the centerlines is aligned with the longitudinal axis of the yoke arm.

13. The rotorcraft of claim 12, wherein the at least three bearings are configured to allow feathering movement of the rotor blade relative to the longitudinal axis, while restricting transverse and longitudinal movement of the rotor blade relative to the longitudinal axis.

14. The rotorcraft of claim 9, wherein the yoke arm comprises a thickness in the range of 0.75 inches to 1.0 inches.

15. The rotorcraft of claim 14, wherein the yoke comprises a length in the range of 27.5 inches and 28.5 inches.

16. The rotorcraft of claim 14, wherein the yoke arm comprises a width in a range of 3.0 inches to 3.5 inches.

17. A tail rotor yoke for a rotorcraft with a teetering tail rotor, the tail rotor yoke comprising:
an elliptically shaped center portion that can receive a tail rotor gearbox;
a first yoke arm extending from the center portion, the first yoke arm comprising at least three spherical bearing receiving sections; and
a second yoke arm extending from the center portion, the first yoke arm comprising at least three spherical bearing receiving sections.

18. The tail rotor yoke of claim 17, wherein the at least three spherical bearing receiving sections are evenly spaced apart.

19. The tail rotor yoke of claim 17, wherein the first and second yoke arm comprise a thickness in the range of 0.75 inches to 1.0 inches.

20. The tail rotor yoke of claim 17, wherein the tail rotor yoke comprises a length in the range of 27.5 inches and 28.5 inches.
